(19) United States
(12) Patent Application Publication
(10) Pub. No.: US 2026/0228504 A1
(43) Pub. Date: Aug. 6, 2026

(54) GRADIENT-FREE OPTIMIZATION OF LARGE LANGUAGE MODELS

(71) Applicant: Salesforce, Inc., San Francisco, CA (US)

(72) Inventors: Romain Cosentino, Palo Alto, CA (US); Sarath Shekkizhar, Seattle, WA (US)

(73) Assignee: Salesforce, Inc., San Francisco, CA (US)

(21) Appl. No.: 19/097,823

(22) Filed: Apr. 1, 2025

Related U.S. Application Data
(60) Provisional application No. 63/752,618, filed on Jan. 31, 2025.

(51) Int. Cl. G06N 3/0475; G06F 40/40

(52) U.S. Cl. CPC G06N 3/0475; G06F 40/40

(57) ABSTRACT

Gradient-free optimization of deep learning models it performed by iteratively improving the text prompt used to instruct the deep learning model to perform a given task. An initial prompt is obtained and used to generate an initial output by the model to be optimized. This output is evaluated by an evaluation model along with reference data, evaluation criteria, etc. The evaluation model's reasoning can be used to generate a new prompt that can be passed back to the deep learning model and used to generate a new model output. This process can continue iteratively until an end condition is met.

### CROSS-REFERENCE TO RELATED APPLICATIONS

This application claims the benefit of U.S. Provisional Application No. 63/752,618, filed Jan. 31, 2025, which is hereby incorporated by reference.

### TECHNICAL FIELD

One or more implementations relate to the field of large language models; and more specifically, to the gradient-free optimization of large language models.

### DESCRIPTION OF THE RELATED ART

The field of Artificial Intelligence (AI) focuses on the implementation of artificial neural network systems that aim to mimic the functionality of neurons in the brain. Machine learning is a sub-area of AI in which a machine learning model is trained to perform one or more specific tasks. For instance, a machine learning model can be trained to perform a target task by relying on patterns and inferences learned from training data, without requiring explicit instructions pertaining to how the task is to be performed.

Large language models (LLMs) are neural networks trained to mimic human language. Specifically, LLMs are trained to predict a next token of a block of text. In operation, LLMs track relationships in sequential data by receiving tokens (e.g., words in a sentence) and predicting a next token (or sequence of tokens). Accordingly, LLMs are well suited to form conversations (e.g., taking turns asking questions and providing responses) by predicting tokens (or sequences of tokens) that are tailored to the style and context of the conversation.

LLMs are trained on billions of tokens mainly extracted from the Internet. The combination of such a vast data landscape and their inherent architecture provides an incredibly powerful general knowledge generator. However, in most practical cases, there is a need for highly specialized LLMs. This allows one to apply the reasoning and generalization properties of LLMs to a particular sub-domain/task.

Training a model from scratch requires both specialized knowledge of the particular LLM being trained as well as access to a significant quantity of general-purpose training data as well as training data that is relevant to the sub-domain/task for which the LLM is being trained. This makes such training outside of the skillset of a typical user.

### BRIEF DESCRIPTION OF THE DRAWINGS

The following figures use like reference numbers to refer to like elements. Although the following figures depict various example implementations, alternative implementations are within the spirit and scope of the appended claims. In the drawings:

FIG. 1 is a block diagram illustrating a gradient-free model optimization system according to some example implementations.

FIG. 2 is a more detailed block diagram illustrating a gradient-free optimization system for generating chat bot configuration data according to some example implementations.

FIG. 3 illustrates example initial prompts according to some example implementations.

FIG. 4 illustrates example evaluation prompts according to some example implementations.

FIG. 5 illustrates example new prompts according to some example implementations.

FIG. 6 illustrates an example reference chat according to some example implementations.

FIG. 7 illustrates example evaluation reasoning according to some example implementations.

FIGS. 8-9 illustrate example generated configuration graphs according to some example implementations.

FIG. 10 is a flow diagram illustrating a method of gradient-free model optimization according to some example implementations.

FIG. 11A is a block diagram illustrating an electronic device according to some example implementations.

FIG. 11B is a block diagram of a deployment environment according to some example implementations.

### DETAILED DESCRIPTION

The following description describes implementations for optimizing a large language model (LLM) without the use of gradient descent. Users can obtain pretrained LLMs and specialize the LLMs to their specific needs. There exist various approaches to specialize an LLM. One such approach is prompt engineering, which involves a Human Agent to test and, through trial and error, determine a “best” prompt for the LLM at hand to tackle a specific task. This approach is costly and slow as it requires Human Agent expertise and time. Additionally, variations between LLMs (e.g., architecture, training data, etc.) means that the best prompt determined for one LLM may not be the best prompt for another LLM. As such, prompt engineering must be performed for every LLM variation in use and regularly updated as those LLMs in use change.

Another approach is fine-tuning. Fine-tuning requires the creation of a dataset and availability of processing resources (e.g., graphics processing units, central processing units, or other general or specialized hardware resources) to fine-tune the model (even when using adapters such as LoRA). Additionally, like training from scratch, fine-tuning typically also requires extensive expertise regarding the training of deep learning models. This approach is also prone to catastrophic forgetting, which results in previously learned capabilities being lost (e.g., “forgotten”) when the LLM learns a new capability. This may include the degradation of critical LLM capabilities (toxicity protection, reasoning, etc.), while fine-tuning for a specific task. As a result, fine-tuning requires a significant amount of expertise and work on training data and evaluation data to be successful. Additionally, even if those resources and expertise are available, not all LLMs allow for fine-tuning.

Training and fine-tuning are traditionally performed using gradient descent techniques. Gradient descent optimizes for a function ƒ via the parameters of the function θ where the parameters are updated using the empirical average of the gradient update on the loss over a batch of data or the entire dataset (x, y)_{1:N}.

Gradient descent involves updating ƒ (e.g., via subtraction), summarization, and evaluation (e.g., of the loss and gradient). Mathematically, gradient descent is represented as:

$${f}_{θ} = {f}_{θ} - \frac{η}{N} {\sum }_{\{ i = 1 : N \}} {Δ}_{θ} [ loss ( {x}_{i} , {y}_{i} ) ] \qquad 1$$

where η is a scaling function or learning rate on the update. However, as discussed, gradient descent-based optimization or fine-tuning of models requires a level of access to the models (e.g., weights, interfaces, etc.) and expertise which is not always available or which requires too many resources.

Various implementations address shortcomings in prior systems by providing a gradient-free approach that can optimize a model without modifying the model's weights. In particular, the mathematical steps of gradient descent described above are replaced with language optimizing steps. Because access to the model's weights, or fine-tuning interfaces, are not required, this enables implementations to be used with both closed- and open-source models. Additionally, it does not require specialized knowledge of deep learning systems on the part of users to optimize a model.

Implementations replace the numerical operations involved with gradient descent with a language model (LM). LMs take as input and provide as output natural language text. This can be used to improve a function ƒ through the process of reasoning built within the LMs. Note that the function to be realized through optimization can be by itself an LM. In other words, implementations reformulate the equation above using multiple language models as below

$${f}_{LM} = UpdateLM ( {f}_{LM} , {SummarizeLM}_{\{ i = 1 : N \}} [ EvalLM ( {x}_{i} , {y}_{i} ) ] ) \qquad 2$$

As such, implementations are able to optimize models using in context learning, which is a feature of models, such as large language models (LLMs), to have an internal learning algorithm. That is, when sending a prompt to an LLM, there exists a learning algorithm that adapts the layers' projections to best interpolate/extrapolate. By changing the prompt, the underlying function of the LLM is effectively changed. As such, finding a better prompt can result in a better output by the LLM.

Past attempts at prompt engineering often involve brute force attempts to find the most effective prompt for a given task. This involves many trial and error attempts, some of which may achieve improved results and some of which may achieve worse results. Unlike these prior systems, implementations iteratively send a prompt to the LLM and evaluate the output of the LLM. Based on this evaluation, a new prompt is generated with the goal of reducing the LLM's error with respect to a specific task. Importantly, the optimization will be performed separately for each sample. This way, each iterative loop results in improved performance by the LLM.

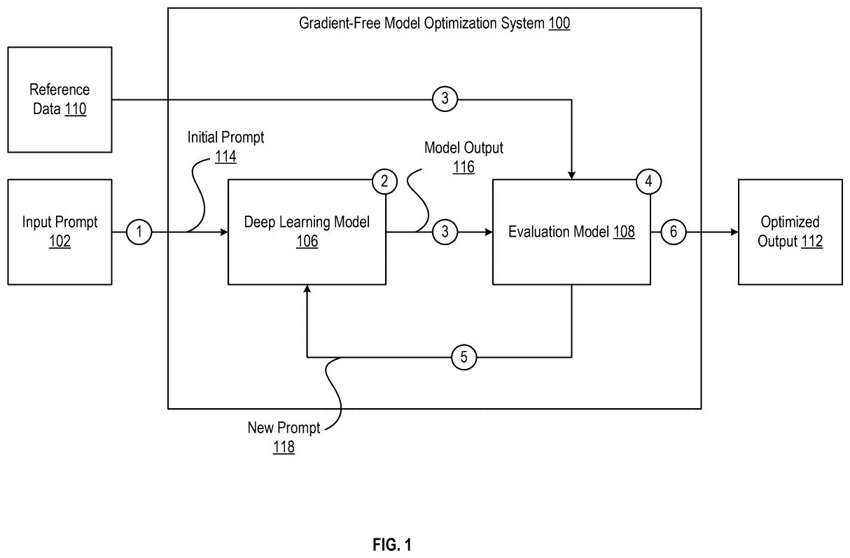

FIG. 1 is a block diagram illustrating a gradient-free model optimization system according to some example implementations. As shown in FIG. 1, a gradient-free model optimization system 100 can be used to optimize a deep learning model 106 to perform a particular task, as instructed by an input prompt 102. The gradient-free optimization system 100 can be implemented as a service in a cloud computing environment (e.g., as an Artificial Intelligence service). In such instances, the gradient-free model optimization system 100 may be implemented using resources available in the cloud computing environment (e.g., hardware or virtual server computers, processing resources, graphics processing resources, memory resources, etc.). In some implementations, the gradient-free model optimization system 100 may be implemented on an end user device, such as a computer, workstation, local private cloud system, etc.

The gradient-free model optimization system 100 includes deep learning model 106, represented by ƒ, and an evaluation model 108, represented by gₑᵥₐₗ. The deep learning network can include a neural network having multiple layers that are designed to learn from data, such as large language models, recurrent neural networks, generative adversarial networks, etc. Implementations can optimize the deep learning model 106 using the evaluation model 108 to iteratively generate more effective prompts. As shown in FIG. 1, at numeral 1 and input prompt 102 is received. This prompt may be received from a user or other entity interacting with the gradient-free model optimization system 100 such as via a user interface provided by gradient-free model optimization system 100 or another system or service in communication with gradient-free model optimization system 100.

The optimization goal of the gradient-free model optimization system 100 is to minimize the following loss function [symbol] . This is used in the gradient free model in place of the evaluation steps of standard gradient descent:

$${min}_{f} ℒ ( f , x \vert {g}_{e v a l} , 𝒞 , R ) \qquad 3$$

In equation 3, the deep learning model 106 is represented by ƒ on the sample x (e.g., a particular initial input prompt 102), [symbol] is a loss function conditioned on the evaluation model 108 gₑᵥₐₗ, a set of criteria [symbol] ={c₁, . . . , c_{T}}, and reference data R such as an external dataset, another model, etc.

At numeral 2, the deep learning model 106 processes the initial prompt 114 and computes ƒ(x) and generates model output 116, which may also be represented as y. In some implementations, the input prompt 102 and the initial prompt 114 may be the same prompt. Alternatively, in some implementations, the input prompt 102 may be preprocessed to include additional information, to change the format of the input prompt 102, etc. At numeral 3, the model output 116 is provided to evaluation model 108. The evaluation model 108 can be another deep learning model similar to deep learning model 106. In some implementations, the deep learning model 106 and evaluation model 108 may be the same model but provided with differing prompts. Also at numeral 3, the evaluation model 108 receives reference data 110. The reference data can include any external data useful in evaluating the performance of the deep learning model 106. This may include ground truth data that the deep learning model 106 should be generating.

At numeral 4, the evaluation model 108 processes the model output 116 and the reference data 110, in view of the set of criteria, to generate an evaluation of the performance of the deep learning model 106. This evaluation may include a numerical score representing the performance of the model (e.g., how closely the model output resembled the reference data and criteria) and text data representing the reasoning of the evaluation model. In some implementations, the prompt provided to the evaluation model at numeral 3 includes the criteria and an instruction to generate the reasoning in text form. This prompt may be generated by the deep learning model 106 and provided with the model output 116 or may be provided by another module of the gradient-free model optimization system 100.

At numeral 5, the evaluation model 108 outputs a new prompt 118 and provides it to deep learning model 106. The new prompt 118 includes the initial prompt 114, the model output 116 and the reasoning generated by evaluation model 108. For example, in some implementations the initial prompt 114, the model output 116 and the reasoning generated by evaluation model 108 are concatenated to generate the new prompt. Steps 2-5 may then be repeated until an end condition is met. The end condition may include a set number of iterations, an error below a threshold value, or other condition. At numeral 6, the optimized output 112 is provided by the gradient-free model optimization system 100, this represents the output of the deep learning model 106 following an end condition.

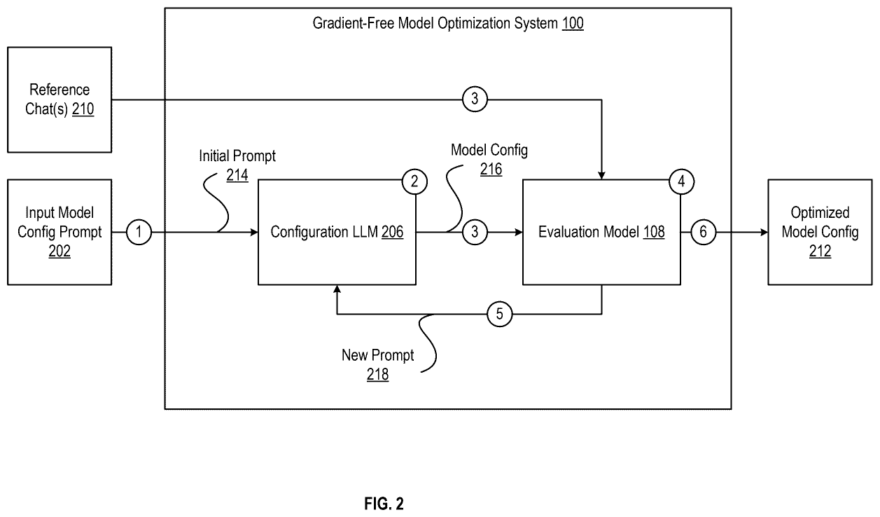

FIG. 2 is a more detailed block diagram illustrating a gradient-free optimization system for generating chat bot configuration data according to some example implementations. As discussed above, the gradient-free model optimization system 100 can be used to optimize various deep learning models which may not be open to fine-tuning or training using gradient descent. In the example of FIG. 2, the deep learning model is a configuration LLM 206. The configuration LLM 206 is an LLM that has been trained to generate a configuration file and conversation graph for a new chat bot.

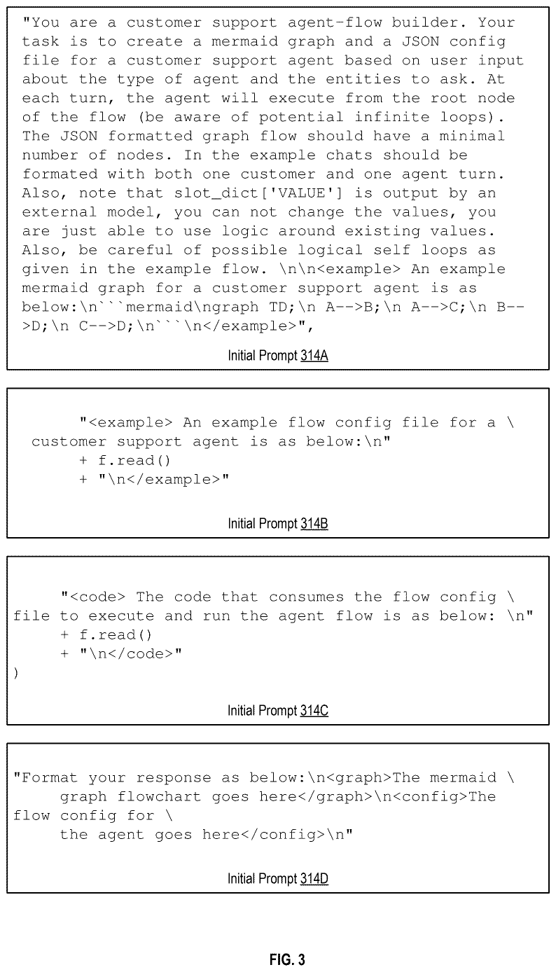

The input model configuration prompt 202 can be a text prompt received from an end-user describing the goal of the model. In this particular example, the end-customer is trying to create a hotel booking bot. As such, the input model configuration prompt 202 may be a text string such as “I need an AI bot for my hotel booking business.” The input model configuration prompt 202 may be augmented with a set of instructions specifying other criteria (e.g., C, discussed above) for the LLM, to create the initial prompt 214. One example of such an initial prompt is shown in FIG. 3.

FIG. 3 illustrates example initial prompts according to some example implementations. Initial prompt 314A shows one example of how the input prompt can be augmented. As shown in FIG. 3, initial prompt 314A adds instructions that specify that the LLM is a customer support agent-flow builder tasked to create a conversation graph (e.g., mermaid graph) and JSON configuration file. In some implementations, an example flow configuration file can be provided. As shown in initial prompt 314B, this can be provided by specifying a storage endpoint, file location, link, or other reference to the example file. Similarly, in some implementations, the initial prompt can also, or alternatively, include code, an application, etc. that will execute the configuration file. This instructs the LLM to generate configuration files that can be executed by the code. As shown in initial prompt 314C, this can also be provided by specifying a storage endpoint, file location, link, or other reference to the example file. Another augmentation can include formatting instructions, as shown in initial prompt 314D. The formatting instructions can instruct the LLM to generate an output that is easily parsable.

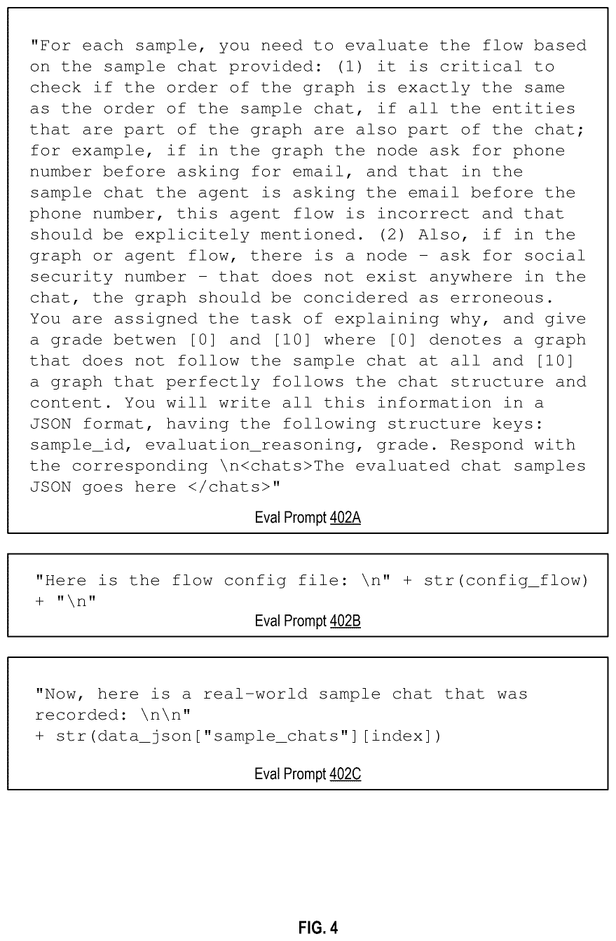

Returning to FIG. 2, the configuration LLM 206 can process the initial prompt 214 and generate an initial model configuration output 216. As discussed, the model configuration output 216 can be evaluated by evaluation model 108 to determine how well the model configuration output 216 complies with the initial prompt instructions and how well they match reference chat(s) 210. The model configuration output 216 and reference chats are provided to the evaluation model at numeral 3. In some implementations, the model configuration output 216 includes a prompt for the evaluation model 108. Example evaluation prompts are shown in FIG. 4.

FIG. 4 illustrates example evaluation prompts according to some example implementations. Evaluation prompt 402A shows one example of a prompt instructing the evaluation model to evaluate the output of the configuration LLM. This prompt can include the set of criteria by which the output is evaluated. For example, the evaluation prompt 402A instructs the evaluation model to check that the order of the graph matches the reference chat and to provide an explanation of any errors identified. Additionally, the example evaluation prompt 402A instructs the evaluation model to provide a score for the model output and specifies the format of the evaluation. The prompt can also specify the model output configuration file to be evaluated, e.g., via file name, link, endpoint, etc., as shown in example evaluation prompt 402B, and the reference chat(s) 210 to be used in the evaluation.

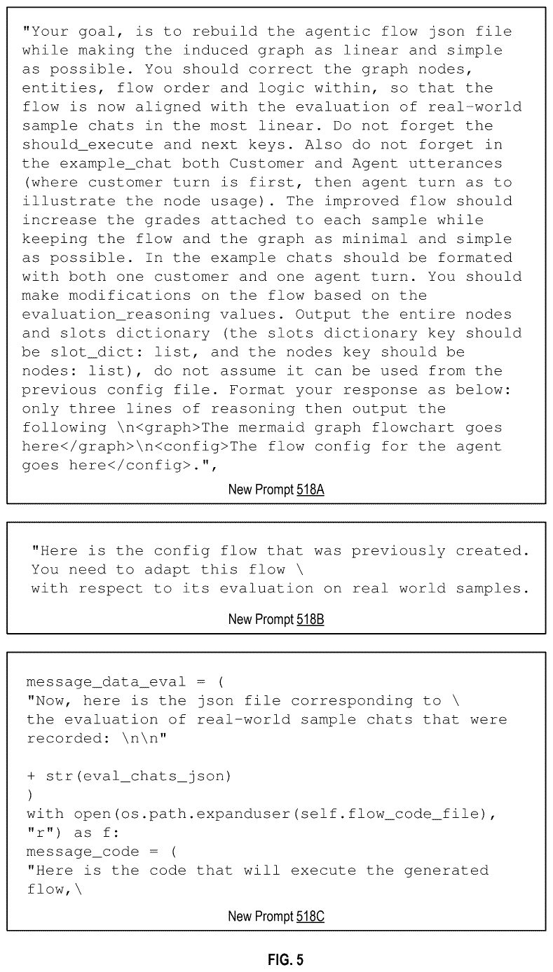

Returning to FIG. 2, at numeral 4 the evaluation model 108 processes the evaluation prompt, reference chat(s) 210, and model configuration 216 to generate an evaluation of the configuration LLM performance. The evaluation model 108 can then output a new prompt 218, as shown at numeral 5. Examples of new prompts are shown in FIG. 5.

FIG. 5 illustrates example new prompts according to some example implementations. New prompt 518A instructs configuration LLM 206 to regenerate the flow making corrections based on the reasoning included in the prompt that was generated by the evaluation model 108. Additionally, in some implementations, the new prompt also include the prior model output, as shown in new prompt 518B. This may be a reference to the prior configuration flow, a file that includes the prior configuration flow, etc. In some implementations, the new prompt may also include the reasoning extracted from the evaluation model, as shown in new prompt 518C. This likewise may be included as a reference to a storage location, file name, etc.

Returning to FIG. 2, as discussed, the processing may loop through steps 2-5 until an end condition is met. In some implementations, each the prompts of each iteration are included cumulatively, allowing each iteration to improve on the mistakes of the prior iterations. In some implementations, each iteration includes prompts based only on the immediately prior iteration. Alternatively, in some implementations, the each iteration may represent an average of the prior iterations. Once the end condition is met, the optimized model configuration 212 is output by the gradient-free model optimization system 100.

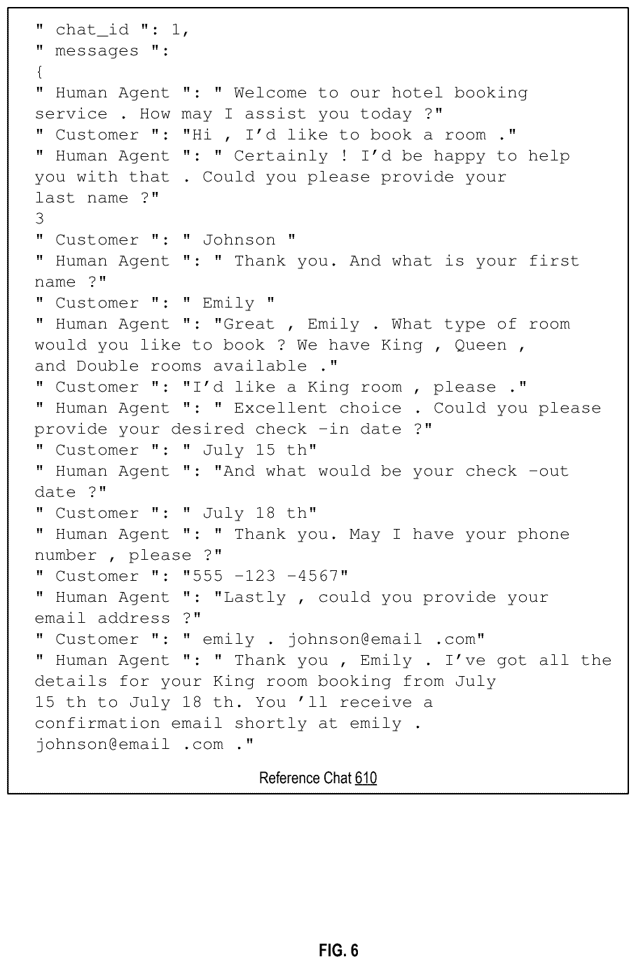

FIG. 6 illustrates an example reference chat according to some example implementations. Reference chat 610 is one example of a reference chat which may be used in accordance with various implementations. Although the reference chat 610 represents a specific customer service flow, various implementations may be used with different reference data. For example, the models are not limited to chat bot configuration models and/or the models may be optimized to perform different tasks. In some implementations, multiple reference chats may be used to evaluate a given model's performance. In such instances, the performance of the model and prompt may be averaged across the reference chats and used to optimize the model's performance using the techniques described herein.

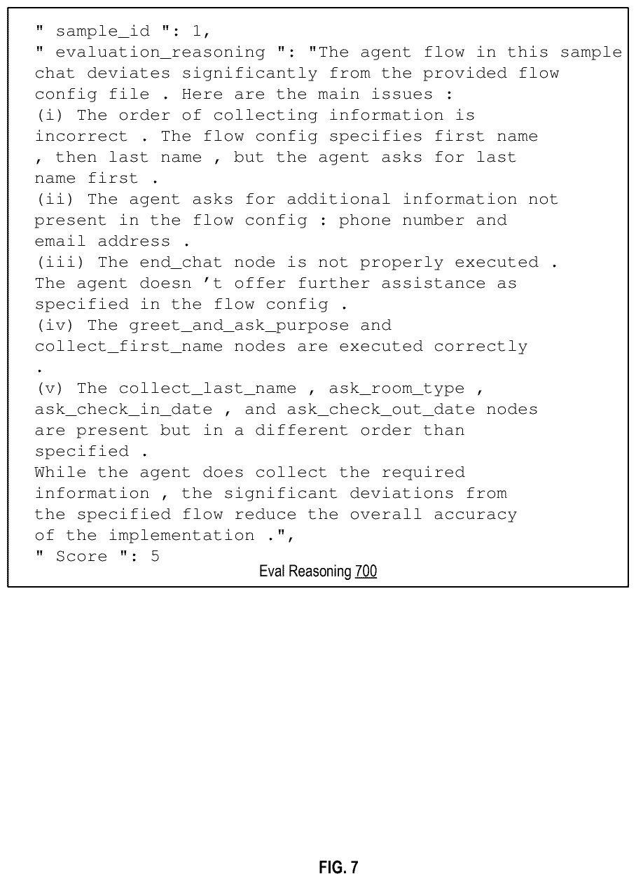

FIG. 7 illustrates example evaluation reasoning according to some example implementations. Evaluation reasoning 700 shows one example of how evaluation reasoning of the evaluation model may be represented in text form. In this example, the errors are enumerated (i)-(v) and a score is provided. As discussed, the specific formatting may vary depending on implementation while the content includes a score and text description of the reasoning of the model.

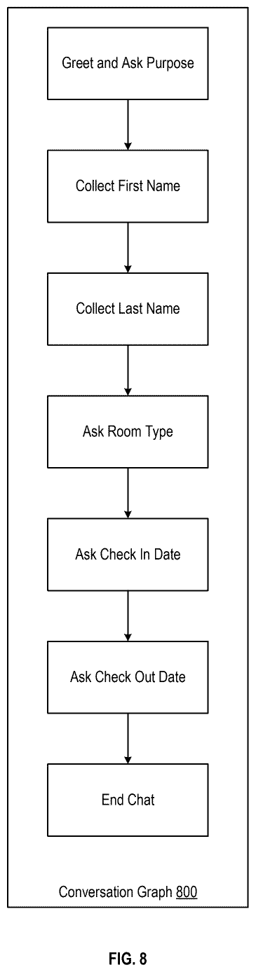

FIGS. 8-9 illustrate example generated configuration graphs according to some example implementations. As discussed, in some implementations, a deep learning model can generate a configuration for a chat bot. In the example of FIG. 8, the initial configuration that is generated includes conversation graph 800. Although not shown, each node in the graph may also include configuration data corresponding to that node which can be used to set up a chat bot to perform a specific task. In this example, a hotel booking agent is being configured. The resulting conversation graph includes a greeting, followed by requests for first and last names, then room time, check in and check out dates, and then the chat ends. As discussed, this conversation graph may be generated based on the instructions included in the initial prompt along with, potentially, example chats.

In a first iteration, this conversation graph, along with the configuration data, original prompt, etc., as discussed above, may then be evaluated by an evaluation model. The results of that evaluation are then incorporated into a new prompt, as discussed, and a new processing loop is executed which includes the deep learning model generates a new conversation graph 900 based on the new prompt. The new conversation graph 900 corrects errors in the old conversation graph. For example, the order of the steps to collect first and last names was reversed in conversation graph 800. Additionally, conversation graph 900 includes requests for contact information (e.g., phone number and email) which were missing in conversation graph 800.

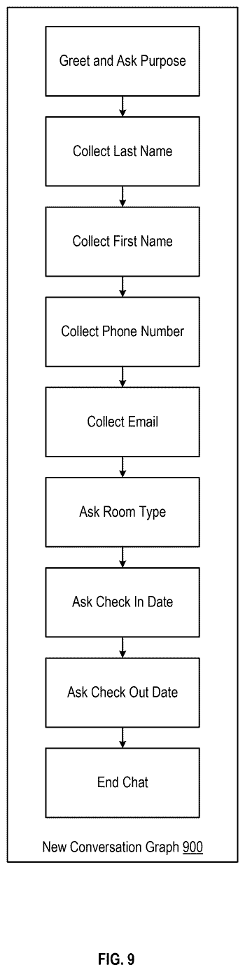

FIG. 10 is a flow diagram illustrating a method of gradient-free model optimization according to some example implementations. In one or more implementations, the method is performed in a digital medium environment that includes the gradient-free model optimization system 100.

As illustrated in FIG. 10, the method includes an act 1060 of obtaining, by a deep learning model, a text prompt describing a task to be performed by the deep learning model. As discussed, the text prompt can be received from an end user and may describe the type of task to be performed. For example, where the deep learning model to be optimized generates configuration data for a chat bot, the text prompt may describe the type of chat bot and/or task which the chat bot will be performing. In some implementations, the text prompt is augmented with additional text data, as discussed. This may include instructions to the deep learning model as to the role of the deep learning model, the types or formats of data to be generated to complete the task, etc.

As illustrated in FIG. 10, the method also includes an act 1062 of generating an output by the deep learning model based at least on the text prompt. The deep learning model can generate an output based on the text prompt, which may be augmented with additional text data. For example, the deep learning model may generate chat bot configuration data, code, images, or any other data relevant to the task at hand. As discussed, this output may not be optimal, e.g., it may not accurately track the instructions, may include information out of order, may include extra information or may be missing information, etc.

As illustrated in FIG. 10, the method also includes an act 1064 of processing the output by an evaluation model to generate a model evaluation. To optimize the performance of the model, the output can be evaluated using an evaluation model. The evaluation model may be another deep learning model or the same deep learning model. In some implementations, the evaluation model is a large language model.

In some implementations, the evaluation model processes the output along with an evaluation prompt that includes criteria for evaluating the output and reference data (e.g., ground truth training data). In some implementations, the evaluation deep learning model generates the model evaluation based at least on the criteria, the reference data, and the output from the deep learning model. This evaluation can include an evaluation score and text data describing a reasoning by the evaluation deep learning model.

As illustrated in FIG. 10, the method also includes an act 1068 of determining whether an end condition has been met. As discussed, various end conditions may be used depending on implementation. For example, the method may iterate for a set number of iterations and then end. Alternatively, the method may iterate until an error score (e.g., as determined by the evaluation model, as discussed) is below a threshold value.

As shown in FIG. 10, the method may loop iteratively such that new outputs are evaluated, and new prompts are generated until an end condition is identified. For example, if an end condition has not been identified then processing may proceed to act 1070. As illustrated in FIG. 10, the method also includes an act 1070 of generating a new prompt based at least on the model evaluation. The model evaluation can include the reasoning employed by the evaluation model which may identify specific errors in the generated output when compared to the evaluation criteria, reference data, etc.

As illustrated in FIG. 10, the method also includes an act 1072 of generating, by the deep learning model, an optimized output based at least on the new prompt. As discussed, this output is optimized by changing the prompt rather than by gradient descent. The new prompt includes instructions to correct the errors found in the previously generated output represented in the reasoning of the evaluation model. As shown, this optimized output can then be evaluated and processing may loop until an end condition is met.

Once an end condition is met, then processing may proceed to act 1074. As illustrated in FIG. 10, the method also includes an act 1074 of returning the optimized output. For example, the optimized output can be returned to the end user. Alternatively, depending on implementation, the optimized output may be provided to another system or service for further processing.

### Example Electronic Devices and Environments

### Electronic Device and Machine-Readable Media

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, machine, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals—such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

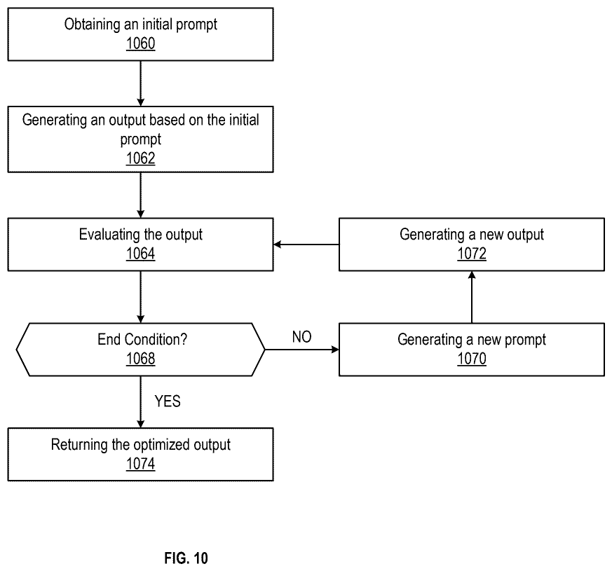

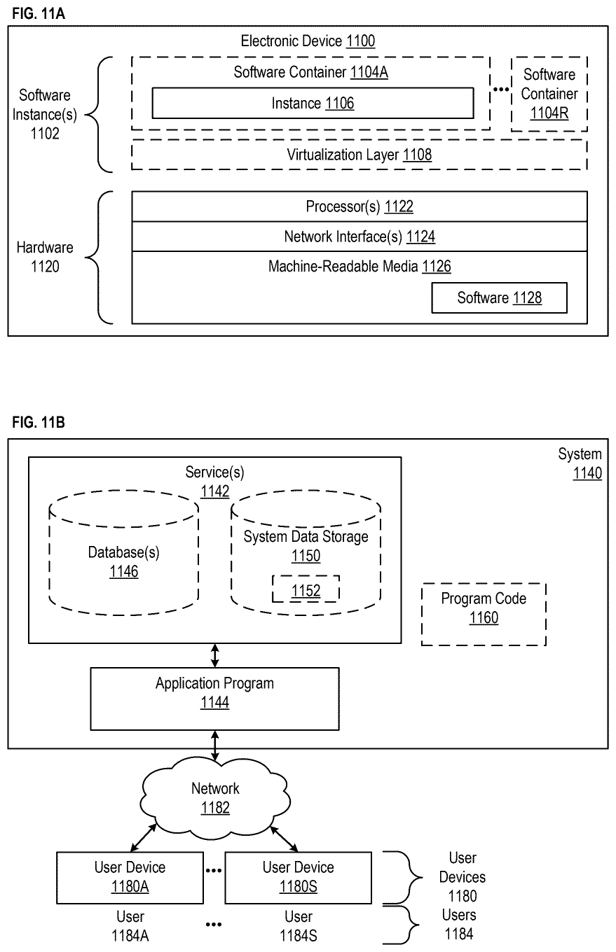

FIG. 11A is a block diagram illustrating an electronic device 1100 according to some example implementations. FIG. 11A includes hardware 1120 comprising a set of one or more processor(s) 1122, a set of one or more network interfaces 1124 (wireless and/or wired), and machine-readable media 1126 having stored therein software 1128 (which includes instructions executable by the set of one or more processor(s) 1122). The machine-readable media 1126 may include non-transitory and/or transitory machine-readable media. Each of the previously described clients and the model optimization service may be implemented in one or more of electronic device 1100. In one implementation: 1) each of the clients is implemented in a separate one of the electronic device 1100 (e.g., in end user devices where the software 1128 represents the software to implement clients to interface directly and/or indirectly with the model optimization service (e.g., software 1128 represents a web browser, a native client, a portal, a command-line interface, and/or an application programming interface (API) based upon protocols such as Simple Object Access Protocol (SOAP), Representational State Transfer (REST), etc.)); 2) the model optimization service is implemented in a separate set of one or more of electronic device 1100 (e.g., a set of one or more server devices where the software 1128 represents the software to implement the model optimization service); and 11) in operation, the electronic devices implementing the clients and the model optimization service would be communicatively coupled (e.g., by a network) and would establish between them (or through one or more other layers and/or or other services) connections for submitting prompts, reference data, etc. to the model optimization service and returning model outputs, such as configuration data, etc. to the clients. Other configurations of electronic devices may be used in other implementations (e.g., an implementation in which the client and the model optimization service are implemented on a single one of electronic device 1100).

During operation, an instance of the software 1128 (illustrated as instance 1106 and referred to as a software instance; and in the more specific case of an application, as an application instance) is executed. In electronic devices that use compute virtualization, the set of one or more processor(s) 1122 typically execute software to instantiate a virtualization layer 1108 and a set of one or more software containers, shown as software container 1104A to software container 1104R (e.g., with operating system-level virtualization, the virtualization layer 1108 may represent a container engine (such as Docker® Engine container runtime by Docker, Inc. or Red Hat® OpenShift container runtime by Red Hat, Inc.) running on top of (or integrated into) an operating system, and it allows for the creation of multiple software containers (representing separate user space instances and also called virtualization engines, virtual private servers, or jails) that may each be used to execute a set of one or more applications; with full virtualization, the virtualization layer 1108 represents a hypervisor (sometimes referred to as a virtual machine monitor (VMM)) or a hypervisor executing on top of a host operating system, and the software containers each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 1128 is executed within the software container 1104A on the virtualization layer 1108. In electronic devices where compute virtualization is not used, the instance 1106 on top of a host operating system is executed on the “bare metal” electronic device 1100. Instances of the software 1128, as well as the virtualization layer 1108 and the software containers if implemented, are collectively referred to as software instance(s) 1102.

Alternative implementations of an electronic device may have numerous variations from that described above. For example, customized hardware and/or accelerators might also be used in an electronic device.

### Example Environment

FIG. 11B is a block diagram of a deployment environment according to some example implementations. A system 1140 includes hardware (e.g., a set of one or more server devices) and software to provide service(s) 1142, including the model optimization service. In some implementations the system 1140 is in one or more datacenter(s). These datacenter(s) may be: 1) first party datacenter(s), which are datacenter(s) owned and/or operated by the same entity that provides and/or operates some or all of the software that provides the service(s) 1142; and/or 2) third-party datacenter(s), which are datacenter(s) owned and/or operated by one or more different entities than the entity that provides the service(s) 1142 (e.g., the different entities may host some or all of the software provided and/or operated by the entity that provides the service(s) 1142). For example, third-party datacenters may be owned and/or operated by entities providing public cloud services (e.g., Amazon Web Services® service by Amazon.com, Inc., Google Cloud Platform™ service by Google LLC, Azure® service by Microsoft Corporation).

The system 1140 is coupled to user devices 1180 (shown as user device 1180A to user device 1180S) over a network 1182. The service(s) 1142 may be on-demand services that are made available to users 1184 (shown as user 1184A to user 1184S) working for one or more entities other than the entity which owns and/or operates the on-demand services (those users sometimes referred to as outside users) so that those entities need not be concerned with building and/or maintaining a system, but instead may make use of the service(s) 1142 when needed (e.g., when needed by the users). The service(s) 1142 may communicate with each other and/or with one or more of the user devices 1180 via one or more APIs (e.g., a REST API). In some implementations, the user devices 1180 are operated by the users 1184, and each may be operated as a client device and/or a server device. In some implementations, one or more of the user devices 1180 are separate ones of the electronic device 1100 or include one or more features of the electronic device 1100.

In some implementations, the system 1140 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant typically includes a group of users with access to at least some of the same data/functionality with the same or similar privileges/permissions. Tenants may be different entities (e.g., different companies, different departments/divisions of a company, and/or other types of entities), and some or all these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all the vendors' data. As another example, in the context of Platform as a Service (PAAS), one set of tenants may be third-party application developers providing applications/services and another set of tenants may be customers of different ones or all the third-party application developers.

Multi-tenancy can be implemented in different ways. In some implementations, a multi-tenant architecture may include software instance(s) that are shared by multiple tenants (e.g., a single database instance share by multiple tenants, sometime referred to as a multi-tenant database; a single application instance shared by multiple tenants, sometimes referred to as a multi-tenant application; a single application instance and a single database instance shared by multiple tenants; an application instance per tenant and a database instance shared by multiple tenants; a single application instance share by multiple tenants and a database instance per tenant).

In one implementation, the system 1140 is a multi-tenant cloud computing architecture supporting multiple services, such as one or more of the following types of services: Customer relationship management (CRM); Configure, price, quote (CPQ); Business process modeling (BPM); Customer support; Marketing; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“app store”); Data modeling; Security; and Identity and access management (IAM).

For example, system 1140 may include an application platform 1144 that enables PAAS for creating, managing, and executing one or more applications developed by the provider of the application platform 1144, users accessing the system 1140 via one or more of the user devices 1180, or third-party application developers accessing the system 1140 via one or more of user devices 1180.

In some implementations, one or more of the service(s) 1142 may use one or more database(s) 1146 and/or system data storage 1150 (which stores system data 1152). In certain implementations, the system 1140 includes a set of one or more servers that are running on server electronic devices and that are configured to handle requests for any authorized user associated with any tenant (there is no server affinity for a user and/or tenant to a specific server). The user devices 1180 communicate with the server(s) of system 1140 to request and update tenant-level data and system-level data hosted by system 1140, and in response the system 1140 (e.g., one or more servers in system 1140) automatically may generate one or more Structured Query Language (SQL) statements (e.g., one or more SQL queries) that are designed to access the desired information from the database(s) 1146 and/or system data storage 1150.

In some implementations, the service(s) 1142 are implemented using virtual applications dynamically created at run time responsive to queries from the user devices 1180 and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 1160 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 1144 includes an application setup mechanism that supports application developers' creation and management of applications, which may be saved as metadata by save routines. Invocations to such applications, including the model optimization service, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 1182 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 11rd Generation Partnership Project (3GPP) protocol, a 4^{th} generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 1140 and the user devices 1180.

Each of the user devices 1180 (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 1140. For example, the user interface device can be used to access data and applications hosted by system 1140, and to perform searches on stored data, and otherwise allow one or more of users 1184 to interact with various GUI pages that may be presented to the one or more of users 1184. The user devices 1180 may communicate with system 1140 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more the user devices 1180 may include an HTTP client, commonly referred to as a “browser,” for sending and receiving HTTP messages to and from server(s) of system 1140, thus allowing one or more of the users 1184 to access, process and view information, pages and applications available from system 1140 over network 1182.

### CONCLUSION

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting.

What is claimed is:

1. A non-transitory machine-readable storage medium that provides instructions that, if executed by a processor, are configurable to cause the processor to perform operations comprising:
obtaining, by a deep learning model, a text prompt describing a task to be performed by the deep learning model;
generating an output by the deep learning model based at least on the text prompt;
processing the output by an evaluation model to generate a model evaluation;
generating a new prompt based at least on the model evaluation; and
generating, by the deep learning model, an optimized output based at least on the new prompt.

2. The non-transitory machine-readable storage medium of claim 1, further comprising:
iteratively evaluating new outputs and generating new prompts until an end condition is identified.

3. The non-transitory machine-readable storage medium of claim 2, wherein the end condition includes a number of iterations or an evaluation score below a threshold value.

4. The non-transitory machine-readable storage medium of claim 1, further comprising:
augmenting the text prompt to create an initial prompt, wherein the initial prompt includes the text prompt and instructions specifying the output to be generated to complete the task.

5. The non-transitory machine-readable storage medium of claim 1, wherein processing the output by an evaluation model to generate a model evaluation, further comprises:
obtaining an evaluation prompt including criteria for evaluating the output;
obtaining reference data; and
obtaining the output from the deep learning model.

6. The non-transitory machine-readable storage medium of claim 5, further comprising;
generating, by an evaluation deep learning model, the model evaluation based at least on the criteria, the reference data, and the output from the deep learning model, wherein the model evaluation includes an evaluation score and text data describing a reasoning by the evaluation deep learning model.

7. The non-transitory machine-readable storage medium of claim 6, wherein the new prompt includes the reasoning by the evaluation deep learning model and instructions to update the output based at least on the reasoning by the evaluation deep learning model.

8. A method comprising:
obtaining, by a deep learning model, a text prompt describing a task to be performed by the deep learning model;
generating an output by the deep learning model based at least on the text prompt;
processing the output by an evaluation model to generate a model evaluation;
generating a new prompt based at least on the model evaluation; and
generating, by the deep learning model, an optimized output based at least on the new prompt.

9. The method of claim 8, further comprising:
iteratively evaluating new outputs and generating new prompts until an end condition is identified.

10. The method of claim 9, wherein the end condition includes a number of iterations or an evaluation score below a threshold value.

11. The method of claim 8, further comprising:
augmenting the text prompt to create an initial prompt, wherein the initial prompt includes the text prompt and instructions specifying the output to be generated to complete the task.

12. The method of claim 8, wherein processing the output by an evaluation model to generate a model evaluation, further comprises:
obtaining an evaluation prompt including criteria for evaluating the output;
obtaining reference data; and
obtaining the output from the deep learning model.

13. The method of claim 12, further comprising;
generating, by an evaluation deep learning model, the model evaluation based at least on the criteria, the reference data, and the output from the deep learning model, wherein the model evaluation includes an evaluation score and text data describing a reasoning by the evaluation deep learning model.

14. The method of claim 13, wherein the new prompt includes the reasoning by the evaluation deep learning model and instructions to update the output based at least on the reasoning by the evaluation deep learning model.

15. An apparatus comprising:
a processor; and
a non-transitory machine-readable storage medium that provides instructions that, if executed by the processor, are configurable to cause the apparatus to perform operations comprising,
obtaining, by a deep learning model, a text prompt describing a task to be performed by the deep learning model;
generating an output by the deep learning model based at least on the text prompt;
processing the output by an evaluation model to generate a model evaluation;
generating a new prompt based at least on the model evaluation; and
generating, by the deep learning model, an optimized output based at least on the new prompt.

16. The apparatus of claim 15, wherein the operations further comprise:
iteratively evaluating new outputs and generating new prompts until an end condition is identified, wherein the end condition includes a number of iterations or an evaluation score below a threshold value.

17. The apparatus of claim 15, wherein the operations further comprise:
augmenting the text prompt to create an initial prompt, wherein the initial prompt includes the text prompt and instructions specifying the output to be generated to complete the task.

18. The apparatus of claim 15, wherein the operation of processing the output by an evaluation model to generate a model evaluation, further comprises:
obtaining an evaluation prompt including criteria for evaluating the output;
obtaining reference data; and
obtaining the output from the deep learning model.

19. The apparatus of claim 18, wherein the operations further comprise:
generating, by an evaluation deep learning model, the model evaluation based at least on the criteria, the reference data, and the output from the deep learning model, wherein the model evaluation includes an evaluation score and text data describing a reasoning by the evaluation deep learning model.

20. The apparatus of claim 19, wherein the new prompt includes the reasoning by the evaluation deep learning model and instructions to update the output based at least on the reasoning by the evaluation deep learning model.
